(19) United States
(12) Patent Application Publication
(10) Pub. No.: US 2021/0038001 A1
(43) Pub. Date: Feb. 11, 2021

(54) Beverage Coaster, System Having a Beverage Coaster, and Method for Data Communication in a System Having a Beverage Coaster

(71) Applicants: Rastal GmbH & Co. KG, Höhr-Grenzhausen (DE); Hoffmann + Krippner GmbH, Buchen (DE)

(72) Inventors: Thomas Nieraad, Hofheim (DE); Ralf Krippner, Buchen (DE); Carsten Kehrein, Koblenz (DE); Michael Nickolai, Wehrheim (DE)

(21) Appl. No.: 16/963,774

(22) PCT Filed: Jan. 21, 2019
(86) PCT No.: PCT/EP2019/051402

§ 371 Date: Jul. 21, 2020

(30) Foreign Application Priority Data
Jan. 22, 2018 (DE) 10 2018 101 332.9

(51) Int. Cl. A47G 23/03; G06K 7/10; H01Q 1/22

(52) U.S. Cl. CPC A47G 23/0306; H01Q 1/2208; G06K 7/10405

(57) ABSTRACT

The present invention concerns a drinks coaster comprising a housing which is so designed that a drinking vessel can be placed thereon, and a wireless electronic communication device arranged in the housing, wherein the communication device is of such a configuration and design that a first wireless communication connection with an interface can be provided by the communication device in operation of the drinks coaster, wherein data can be transmitted at least from the communication device to the interface. In comparison the object of the present invention is to provide a drinks coaster which in a simple fashion makes it possible to also acquire and/or process information about a drinking vessel placed on the drinks coaster and/or about a drink in the drinking vessel. To attain that object it is proposed that the drinks coaster is further developed in such a way that the communication device is further configured and designed that a second wireless communication connection with a contactlessly readable electronic information carrier mounted on a drinking vessel can be provided by the communication device in operation of the drinks coaster, wherein data can be read at least out of the electronic information carrier and transmitted to the communication device.

The present invention concerns a drinks coaster comprising a housing which is so designed that a drinking vessel can be placed thereon, and a wireless electronic communication device arranged in the housing, wherein the communication device is of such a configuration and design that a first wireless communication connection with an interface arranged outside the drinks coaster can be provided by the communication device in operation of the drinks coaster, wherein data can be transmitted at least from the communication device to the interface.

The present invention also concerns a system comprising such a drinks coaster and an interface arranged outside the drinks coaster, wherein a wireless communication connection is provided between the communication device of the drinks coaster and the interface so that data can be transmitted at least from the communication device of the drinks coaster to the interface.

The present invention further concerns a method of communication with a drinks coaster.

Digitisation of many areas in life is continuing to proceed more and more. That also includes the point that more and more articles in everyday life are linked into data networks to be able to exchange data with those articles. This is also referred to as the Internet of Things.

Thus German Utility Model DE 20 2006 003 621 U1 discloses a drinks coaster having a wireless electrical communication device which can be linked into a data network and a sensor. In that way, when the sensor detects a predetermined measurement value, a signal can be sent to the bar staff, for example to place a repeat order. In that case the drinks coaster is associated with a table of the restaurant or tavern, but it does not process any additional information about the drinking vessel placed on the drinks coaster, or its content.

In comparison the object of the present invention is to provide a drinks coaster, a system comprising such a drinks coaster and a method of communication with such a drinks coaster, which in a simple manner makes it possible to also acquire and/or process information about a drinking vessel placed on the drinks coaster and/or about a drink in the drinking vessel.

At least one of the above-mentioned objects is attained by a drinks coaster comprising a housing which is so designed that a drinking vessel can be placed thereon, and a wireless electronic communication device arranged in the housing, wherein the communication device is of such a configuration and design that a first wireless communication connection with an interface can be provided by the communication device in operation of the drinks coaster, wherein data can be transmitted at least from the communication device to the interface, wherein the communication device is further configured and designed that a second wireless communication connection with a contactlessly readable electronic information carrier mounted on a drinking vessel can be provided by the communication device in operation of the drinks coaster, wherein data can be read at least out of the electronic information carrier and transmitted to the communication device of the drinks coaster.

The drinks coaster according to the invention has the advantage that it can both communicate data to an interface, for example of a data network, and can also read out data from a contactlessly readable electronic information carrier fixed to a drinking vessel. In that way an association is possible between a drinking vessel and its content and the consumer who has the drinks coaster in front of him.

It will be appreciated that the interface is not part of the drinks coaster but rather is an external element, that is to say arranged outside the drinks coaster, for receiving the data transmitted by the communication device of the drinks coaster.

The housing of the drinks coaster can be made from entirely different materials or also from a combination of various materials. Plastic, wood, cardboard and metal is particularly suitable as the material for the housing. In that respect in an embodiment of the invention the housing has a closed volume in which the communication device and possibly further electronic and electrical devices are accommodated.

What is paramount for the housing is that a drinking vessel can be placed thereon. For that purpose in an embodiment of the invention the housing has a top side having a carrier surface. The carrier surface serves as a receiving surface for the base or the bottom of the drinking vessel.

It will be appreciated that the carrier surface desirably is of an area larger than the typical area of the base or the bottom surface of the drinking vessel on which it stands. In an embodiment the diameter of a circular carrier surface or a side length of a rectangular or square carrier surface is 15 cm or less. In that way the base or the bottom surface of the drinking vessel can be set down, but the drinks coaster can still be handled.

In an embodiment the drinks coaster is in the form of a drinks temperature control means, in particular a bottle cooler or a beer warmer. Such a drinks temperature control means has a carrier surface for receiving the base or the support surface of a drinking vessel, but in an embodiment additionally defines a volume for receiving a temperature-controlled fluid, for example water.

In an embodiment of the invention the housing has a top side with a carrier surface and an rim which at least portion-wise surrounds the carrier surface and projects with respect to the carrier surface so that a beer mat can be received on the carrier surface and within the rim. In an embodiment the rim projects by 10 mm or less with respect to the carrier surface (measured perpendicularly to the carrier surface).

If the housing is made from plastic, metal or wood it can absorb scarcely any or no condensation water running off the drinking vessel. Therefore an embodiment of the drinks coaster with a rim projecting with respect to the carrier surface makes it possible to accommodate a conventional beer mat (also referred to as a drip mat). The claimed drinks coaster then serves as a holder for the actual beer mat.

In an embodiment of the invention such a beer mat is received on a carrier surface of the top side of the housing. In an embodiment of the invention the beer mat comprises wood pulp cardboard of spruce.

While beer mats are known in various shapes and sizes the beer mat in an embodiment is of a square or round shape. It will be appreciated that the dimensions of the carrier surface but in particular of the rim which at least portion-wise surrounds the carrier surface must be such that the beer mat can be placed thereon. Round beer mats in an embodiment are of a diameter of 107 mm so that the carrier surface is then also of a diameter of about 107 mm.

The term drinking vessel in accordance with the present invention is used to denote a drinking vessel irrespective of the choice of its material. In an embodiment the drinking vessel is a drinking vessel of glass. Drinking vessels in accordance with the present application include drinking glasses, beakers, vessels with handles like beer mugs, cups and pitchers, fancy vessels but also bottles or drinking bottles.

The term wireless electronic communication device in accordance with the present invention denotes one or more electronic circuits which can receive and/or emit a signal. It will be appreciated that the emitted signal has to be modulated in one of the known ways to transmit data from the communication device.

In that respect in accordance with the present invention the wireless communication connections which can be produced by the communication device are direct communication connections, that is to say point-to-point, that is to say for example between an interface of a data network and the communication device of the drinks coaster, between a contactlessly readable electronic information carrier and the communication device of the drinks coaster or between a mobile terminal device and the communication device of the drinks coaster.

What is crucial for the present invention is that the communication device is capable of establishing two wireless communication connections. In that case both communication connections are unidirectional in an embodiment. The communication connection between the communication device of the drinks coaster and an interface makes it possible to communicate data at least from the drinks coaster to the interface. The communication connection between the drinks coaster and the information carrier in contrast makes it possible to communicate data at least from the information carrier to the drinks coaster.

In an embodiment however at least one of the first or the second wireless communication connections is bidirectional so that data can be transmitted in both directions.

In an embodiment of the invention the contactlessly readable electronic information carrier with which the communication device of the drinks coaster can establish a communication connection is an RFID transponder. In an embodiment of the invention a link between the communication device of the drinks coaster and such an RFID transponder is effected either by means of a magnetic alternating field of short range or by high-frequency radio waves.

In an embodiment of the invention the RFID transponder is a transponder in accordance with the NFC standard. Such transponders can be read with conventional mobile terminal devices, for example a smartphone or a tablet, and are inexpensive and available on a mass-produced basis.

In an embodiment of the invention the RFID transponder is a passive RFID transponder. That is supplied with power from a signal sent from a reading device to the transponder.

In an alternative embodiment the RFID transponder is an active transponder with its own power source, for example a battery or an accumulator, for power supply at least to the processing circuit and/or the transmitter or receiver circuit.

It will be appreciated that the communication device of the drinks coaster, depending on the respective configuration of the contactlessly readable information carrier, that is to say in particular the RFID transponder, has the devices required for reading out the information carrier, that is to say in particular emitting and receiving elements (for example antennas). In an embodiment of the invention the communication device includes a reading device for an RFID transponder.

The contactlessly readable information carriers which can be read by means of the communication device of the drinks coaster can be connected to quite different items which do not belong to the drinks coaster. For example a contactlessly readable information carrier is connected to or can be mounted to a drinking vessel. It will be noted however that a contactlessly readable information carrier mounted to a table of the catering establishment or a contactlessly readable information carrier of a mobile terminal device, for example a mobile telephone, can also be read out with the communication device.

In an embodiment of the invention the communication device is so designed and adapted that the first wireless communication connection operates in accordance with a first transmission standard and the second wireless communication connection operates in accordance with a second transmission method or standard different from the first transmission method or standard.

In that respect in an embodiment of the invention the communication device of the drinks coaster is so designed and adapted that the first wireless communication connection is a wireless LAN connection, a Bluetooth connection, a mobile radio connection or an LPWA (low power wide area) connection and the second wireless communication connection is a connection for reading out an RFID transponder, preferably a connection in accordance with the NFC standard. A mobile radio connection or an LPWA connection has the advantage that the drinks coaster can be directly connected by way thereof to an interface of an existing data network infrastructure, for example a mobile radio receiver or an LPWA gateway and there is no need to set up in the catering establishment a specific interface, for example in the form of a Bluetooth hub or a WLAN router.

In a further embodiment of the invention the drinks coaster has a measuring device or a sensor for detecting a measurement parameter, the measuring device being operatively connected to the communication device so that the measurement parameter can be transmitted in the form of data at least by way of the first communication connection to the interface.

In an embodiment the measuring device is an optical sensor, for example for detecting a movement of the drinks coaster or a movement of the drinking vessel.

In a further embodiment the measuring device is an acceleration sensor, for example for detecting a movement or an orientation of the drinks coaster.

Furthermore in an embodiment the measuring device is a motion sensor, for example for detecting a movement of the drinking vessel.

It is appreciated that the measuring device is accommodated in or on the drinks coaster.

In an embodiment the measuring device has a filling level measuring device arranged in the housing, wherein the filling level measuring device is so designed and adapted that as the measurement parameter a filling level of a drinking vessel placed on the housing can be detected with the filling level measuring device and wherein the filling level measuring device is so connected to the communication device that measurement data generated by the filling level measuring device can be transmitted to the communication device. In that respect the term filling level measuring device is used to denote any kind of sensor which directly or indirectly can determine a measurement in respect of the filling level of the drinking vessel placed on the housing.

In an embodiment of the invention the filling level measuring device is a force sensor so designed and arranged that a weight of a drinking vessel placed on the drinks coaster can be detected with the force sensor in operation of the drinks coaster. For that purpose in an embodiment of the invention the force sensor is arranged under a carrier surface of the housing which receives the base or the bottom of the drinking vessel to detect the weight of the drinking vessel. It will be appreciated that the weight of the drinking vessel is greater if the drinking vessel is filled with a drink.

It is advantageous if, in a filling level measurement about the weight of the more or less full drinking vessel, the weight of the drinking vessel itself is known in order to be able to determine the net weight of the drink and thus the filling level. The tare weight of the drinking vessel can in that case be stored in particular in the information carrier mounted to the drinking vessel, in the form of data which can be read out by the communication device of the drinks coaster.

In an alternative embodiment of the invention the filling level measuring device is a capacitive sensor of such a design and configuration that in operation of the drinks coaster an electrical capacitance depending on the filling level of the drinking vessel placed on the drinks coaster can be detected with the capacitive sensor. In a further embodiment of the invention the filling level measuring device is an optical sensor for detecting the filling level.

It is appreciated that the drinks coaster can have a plurality of measuring devices.

In a further embodiment of the invention the communication device is further so designed and adapted that in operation of the drinks coaster a third wireless communication connection with a mobile terminal device can be provided by the communication device, wherein data can be read at least out of the mobile terminal device and transmitted to the communication device. It will be appreciated that in an embodiment this third wireless communication connection is a direct and immediate communication connection, that is to say point-to-point, between the communication device of the drinks coaster and the terminal device.

In an embodiment of the invention a payment process is handled or the implementation thereof is initiated by way of the third wireless communication connection. For that purpose in an embodiment the drinks coaster is connected to the till system of the catering establishment by way of the first wireless communication connection.

The term mobile terminal device in accordance with the present invention is used to denote in particular a mobile telephone, a smartphone, a tablet computer or the like. In such a configuration in which the communication device produces overall three communication connections, namely to the interface, to the information carrier on the drinking vessel and to a mobile terminal device, it is possible to obtain and link together a large number of items of information. Those items of information include in particular data about the user of the mobile terminal device, that is to say in particular the consumer of the drink in the drinking vessel, data associated with the drinks coaster itself, for example the table number of a catering establishment, and data associated with the drinking vessel, for example a tare weight, the drink in the drinking vessel and the like.

In a further embodiment of the invention the drinks coaster has an operating element operatively connected to the communication device, wherein the operating element is preferably selected from a button and a switch, a capacitive button or a touch-sensitive display. In that way the drinks coaster can also be used as a user interface, by means of which the consumer of the drink can send a signal for example to the operating staff or the bar staff.

In a further embodiment of the invention the drinks coaster has a display element operatively connected to the communication device, the display element preferably being a display or at least one light emitting diode. In that way the drinks coaster can be used as a user interface and a signal can be displayed to the consumer of the drink.

In an embodiment the drinks coaster has a vibration alarm. In that case the vibration alarm is a signal generator which by vibration signals the occurrence of an event. A vibration alarm is advantageous if for example a light signal cannot be clearly seen in an outside establishment.

In a further embodiment of the invention the drinks coaster has a respective power supply arranged in the housing and connected to the communication device, in particular an accumulator. It will be appreciated that such an accumulator can be charged by replacement, inductively or by a cable connection, for example using a USB cable.

In an embodiment the drinks coaster has an inductive charging device for charging an accumulator of a mobile terminal device. In that way a guest can use the drinks coaster as a powerpack for his mobile terminal device, in particular his mobile telephone.

The listing of electronic devices which the drinks coaster can have is not conclusive and definitive. In particular a processor or computer operatively connected to the other electronic devices can be arranged in the drinks coaster.

Depending on the respective embodiment and configuration the drinks coaster according to the invention makes it possible to achieve a whole series of advantages, inter alia:
in an embodiment the drinks coaster according to the invention can be placed for example under a bar bottle in order for example to indicate the real time consumption of spirits. In an embodiment in that case the drinks coaster is fully pre-programmed. In an embodiment the weight of the bottle is stored electronically in the drinks coaster. In that case no chip on the bottle is required;
in an embodiment the drinks coaster can be used as an ingredients scale for mixtures of a cocktail.

At least one of the above-mentioned objects is also attained by a system having a drinks coaster as described hereinbefore and hereinafter in embodiments thereof, an interface and a drinking vessel, having a contactlessly readable electronic information carrier fitted thereon, wherein a first wireless communication connection is provided between the communication device of the drinks coaster and the interface so that data can be transmitted at least by the communication device of the drinks coaster to the interface and wherein a second wireless communication connection is provided between the communication device of the drinks coaster and the information carrier so that data can be read at least out of the electronic information carrier and transmitted to the communication device of the drinks coaster.

In an embodiment a contactlessly readable electronic information carrier in accordance with the present invention includes a carrier substrate, in particular a carrier substrate of plastic. In addition in an embodiment the information carrier includes an electronic circuit having a transmitting circuit for emitting a signal, a processing circuit and a permanent memory. Such electronic circuits are known in many different forms from the state of the art.

In that respect individual parts of the electronic circuit can be integrated in an integrated circuit, namely a chip. A signal in accordance with the present invention can then be a magnetic, electromagnetic or optical signal. Preferred embodiments however are those in which the signal is modulated on to a magnetic field or an electromagnetic field.

In an embodiment of the invention the electronic circuit of the information carrier, in addition to the integrated circuit, also includes a receiver circuit for receiving a signal. It will be appreciated that this receiver circuit is then also connected to the processing circuit.

In an embodiment of the invention the transmitter and/or receiver circuit of the information carrier are analog circuits. In a further embodiment of the invention the processing circuit is a digital circuit. In an embodiment such a digital processing circuit is a microcontroller.

In a further embodiment the circuit also has an antenna connected to the transmitter and/or receiver circuit. That serves to emit or receive the signal in the form of a magnetic field or an electromagnetic field.

In an embodiment the information carrier is also operatively connected to a display device arranged on the drinking vessel, for example a light emitting diode or a display, which can be activated or controlled by means of a signal transmitted from the interface by way of the drinks coaster to the information carrier connected to the drinking vessel. Real time sweepstakes can be carried out by virtue of that configuration.

In an embodiment of the system according to the invention the interface is an access point of a data network or an interface of a mobile terminal device. Such a wireless access point of a data network is for example an access point or a router. The data network to which the interface forms an access point is for example a wired data network, in particular a WAN or an LAN.

In a further embodiment of the invention the system includes a mobile terminal device, wherein a third wireless communication connection is formed between the communication device of the drinks coaster and the mobile terminal device so that data can be read out at least from the mobile terminal device and transmitted to the communication device of the drinks coaster.

In an embodiment the system further includes a table with a contactlessly readable information carrier mounted thereto, in particular an RFID or NFC transponder, or a stand for a table having a contactlessly readable information carrier mounted to the stand, in particular an RFID or NFC transponder. That contactlessly readable information carrier fixed to the table can also be read out by means of a wireless communication connection between the communication device of the drinks coaster and the information carrier.

Depending on the respective configuration of the drinks coaster and the system architecture the system according to the invention makes it possible to achieve a whole series of advantages. By way of example the following scenarios may be mentioned:
in an embodiment the system according to the invention makes it possible to detect consumption and consumer information. Thus it is possible for the first time for example to establish drinking profiles, like for example the drinking speed per glass, the number of swallows per drink and the volume and duration of consumption, and so forth;
in an embodiment the system according to the invention can specify the most effective routes for the serving staff to achieve optimum serving services.

Insofar as aspects of the invention are described hereinafter in relation to the method according to the invention they also apply to the system according to the invention with a drinks coaster and for the drinks coaster and vice-versa. If the method with the drinks coaster or the system according to the invention is carried out then they have the corresponding devices for that purpose. In particular embodiments of the drinks coaster or the system are suitable for carrying out embodiments described hereinafter of the method.

At least one of the above-mentioned objects is also attained by a method of data communication in a system comprising a drinks coaster having a housing which is so adapted that a drinking vessel can be placed thereon, and a wireless electronic communication device arranged in the housing, an interface and a drinking vessel with a contactlessly readable electronic information carrier mounted thereto, wherein by way of a first wireless communication connection data can be transmitted at least from the communication device of the drinks coaster to the interface and wherein by way of a second wireless communication connection data are read at least out of the electronic information carrier and transmitted to the communication device of the drinks coaster.

It is appreciated that the system preferably has a plurality of drinks coasters according to the invention and a plurality of drinking vessels with contactlessly readable information carriers fitted thereto and one-to-one identifying the respective drinking vessel.

In an embodiment the communication device transmits the data read out of the electronic information carrier to the interface by way of the first communication connection. In that case transmission of the data read out of the electronic information carrier is preferably effected together with data which are stored in a device in the drinks coaster and/or which were detected by a measuring device in the drinks coaster.

In an embodiment the system further includes a table having a contactlessly readable electronic information carrier mounted thereto or a stand with a contactlessly readable electronic information carrier fitted thereto for placement on a table, wherein by way of a wireless communication connection data can be at least read out of the electronic information carrier and transmitted to the communication device of the drinks coaster.

The arrangement of an electronically readable information carrier on a table or a stand for placement on a table permits logical association of a drinks coaster according to the invention with a given table, for example in a catering establishment.

It is appreciated that the system preferably has a plurality of tables or stands for tables with contactlessly readable information carriers fitted thereto and one-to-one identifying the respective table or stand.

In an embodiment of the invention for that logical link between the drinks coaster and the table the drinks coaster is held in front of the electronically readable information carrier of the table or stand and the information carrier is read out by the communication device of the drinks coaster.

In an embodiment the login of a drinks coaster to a table or stand, that is to say the successful logical association between those components, is acknowledged with triggering of a vibration alarm or a light signal.

In an embodiment the information carrier of the table or stand has a one-to-one identification. In an embodiment information carriers mounted to a table or a stand for the table are pre-programmed with a one-to-one identification such that the system, after the information carrier is read out by the communication device of the drinks coaster, recognises that this is a table identification and can logically associate the respective drinks coaster with that table. In an embodiment of the method according to the invention it is possible for the identification of the information carrier to be associated one-to-one with a table in software. For that purpose either a table or a table number is graphically selected and allocated to the identification of the information carrier of the table or the stand.

In an embodiment of the invention the read-out of data from the electronic information carrier by way of the second communication connection or the transmission of data from the communication device to the interface is initiated by detection of a measurement value with a measuring device. For example the placement of a drinking vessel on the drinks coaster can be detected by means of a weight sensor in the drinks coaster. That detection then serves as a trigger signal to read out the electronic information carrier on the drinking vessel and to transmit the read-out data together with the data stored in the drinks coaster to the interface. Equally for example the fact that the filling level has fallen below a certain predetermined level can trigger the transmission of data, in particular a fresh order.

Further advantages, features and possible uses of the present invention will be apparent from the description of embodiments hereinafter and the accompanying Figures.

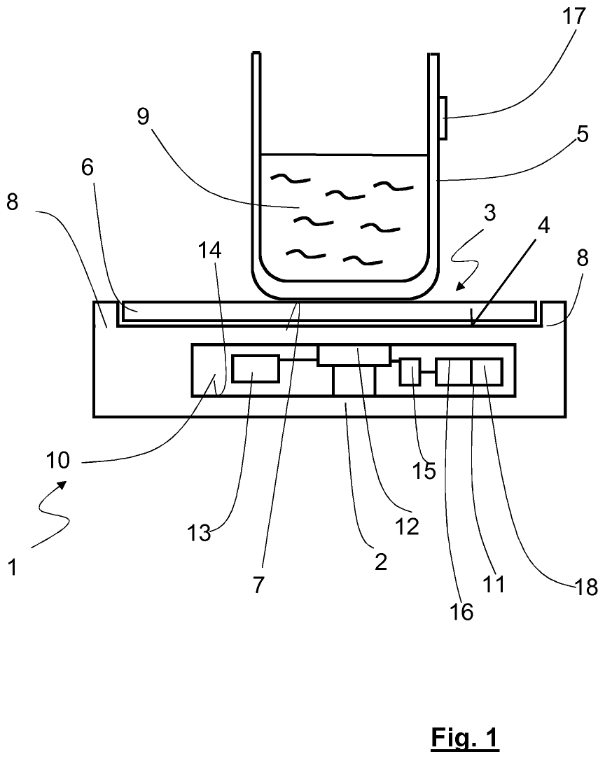

FIG. 1 shows a cross-sectional view through a drinks coaster according to an embodiment of the present invention,

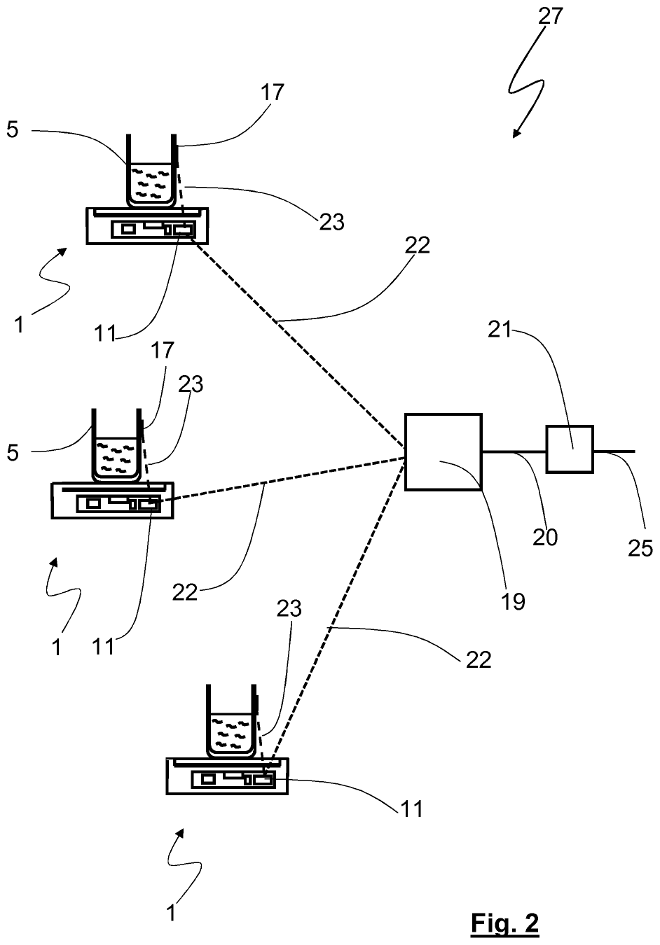

FIG. 2 shows a diagrammatic view of an embodiment of a system with the drinks coaster of FIG. 1, and

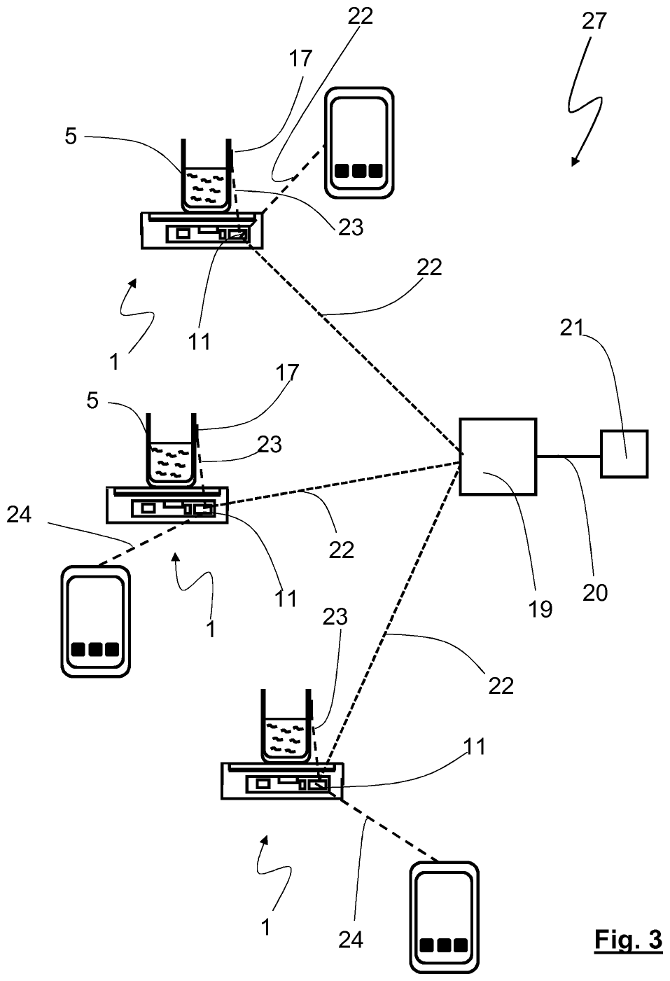

FIG. 3 shows a diagrammatic view of a further embodiment of a system with a drinks coaster as shown in FIG. 1.

In the Figures identical components are denoted by the same references.

FIG. 1 shows a diagrammatic cross-sectional view of a drinks coaster 1 according to the invention.

The drinks coaster 1 includes a housing 2 which is of a shallow structure, of a height markedly less than its length and its width. The housing 2 at its top side 3 has a carrier surface 4 serving as a surface for a drinking vessel, here a drinking glass 5, to stand thereon.

In the illustrated embodiment the carrier surface 4 is such that a beer mat 6 is received thereon, the beer mat extending between the bottom 7 of the drinking glass 5 and the carrier surface 4 of the housing after the drinking glass 5 has been put down. In the illustrated embodiment the beer mat 6 is a round beer mat of a diameter of 107 mm which is made from wood pulp cardboard. The carrier surface 4 is surrounded by a circular rim 8 so that the beer mat 6 cannot slip off the carrier surface 4 or slide in relation thereto. The rim 8 is substantially of a height in relation to the carrier surface 4, that is equal to the thickness of the beer mat 6. The beer mat 6 serves to absorb condensation water and any spilt drops of the drink 9 in the drinking glass 5.

Disposed in the interior of the housing 2 is a compartment 10 in which an electronic circuit having a plurality of elements is received. In the illustrated embodiment the electronic circuit includes a communication device 11, a force sensor 12, a processor 15 and an inductively chargeable accumulator 13.

The accumulator 13 serves to supply electric power to the force sensor 12 and the communication device 11. The force sensor 12 is arranged beneath the carrier surface 4 of the housing so that it detects a force acting on the carrier surface 4 and thus on the housing 2. The force sensor 12 is then supported at the opposite wall 14 of the compartment 10. When now the drinking glass 5 is put down on the beer mat 6 on the carrier surface 4 the force due to the weight of the drinking glass 5 and the drink 9 therein presses against the carrier surface 4 and by way thereof against the force sensor 12. The force detected by the force sensor 12 is proportional to the weight or mass of the drinking glass 5 with the drink 9 therein. If the tare weight of the drinking glass 5 is known then it is possible from the force measurement of the force sensor 2 to arrive at the mass of the drink 9 in the drinking glass 5 or the filling level of the drinking glass 5.

In the illustrated embodiment the sensor 12 is operatively connected to a logic means, that is to say on the processor 15, which causes a fresh order for a drink to the bar staff when the filling level falls below a predetermined level.

In principle the glasses 5 placed on the drinks coaster 1 can be of quite different shapes and sizes and thus masses. So that the respectively correct tare weight for filling level measurement can be implemented by means of the force sensor 12 the drinks coaster 1 has a communication device 11 which on the one hand includes an RFID reader 16. It serves to read out a RFID transponder 16 on the glass 5. The RFID transponder 17 using the terminology employed in the present application is a contactlessly readable electronic information carrier, in the illustrated embodiment involving specific information in the form of data which one-to-one identify the type of glass 5, the tare weight of the glass 5 and the type of drink 9. On the basis of that information which the RFID reader 16 reads out and transmits to the logic means 15 the logic means 15 can evaluate the measurement data from the force sensor 12 and determine when a fresh order has to be initiated. The further order 15 is transmitted to the communication device 11 by means of a command in the form of data and forwarded by the device 11. For that purpose the communication device 11 has a Bluetooth module 18 which provides a communication connection to a network interface 19.

FIG. 2 now shows a diagrammatic view of a system 27 having a multiplicity of drinks coasters 1 of the configuration of that shown in FIG. 1. A drinking glass 5 with an RFID transponder 17 fitted thereto is arranged on each of the drinks coasters 1. The respective communication device 11 provides a first wireless communication connection between the drinks coaster and the interface 19. In that respect the interface 19 is a Bluetooth access point for a data network 20 connecting the access point 19 to a computer 21. The data network is an LAN network, wherein the computer 21 can also communicate with a server by way of the Internet 25 (this is not shown). The Bluetooth connections 22 form first wireless communication connections between the communication devices 11 and the interfaces 19 using the terminology of the present application.

The NFC connections between the communication devices 11 and the RFID transponder 17 on the drinking glasses 5 form the second wireless communication connection 23 using the terminology of the present application.

The architecture diagrammatically shown for three drinks coasters 1 in FIG. 2 is suitable for a large number of drinks coasters, in which respect not only every RFID transponder 17 and thus each drinking glass 5 has an individual one-to-one identification, but also each drinks coaster 1 has a one-to-one identification. In that case, when putting out the drinks coasters an association of the respective drinks coaster 1 with the table or a customer is stored in the database of the computer 21. If the filling level of one of the drinking glasses 5 falls below a predetermined threshold the drinks coaster 1 on which the drinking glass 5 is disposed initiates a further order, more specifically for that drink which is identified by means of the RFID transponder on the drinking glass 5.

FIG. 3 shows an enlarged architecture of the system 27′, in which each of the communication devices 11 additionally provides a third communication connection 24 from the drinks coaster 1 to a smartphone 26 of the customer or consumer. Personal data about the consumer can be interrogated by way of that communication connection 24 and passed for statistical evaluation. For example an age query for preventing sale of alcohol to minors can also be implemented.

While the embodiment of the drinks coaster 1 of FIG. 1 does not have any user interfaces besides the force sensor 12 embodiments are also conceivable in which the drinks coaster additionally has a display element, for example in the form of a light emitting diode, and an operating element, for example a button. In that way further orders can be manually initiated or catering services provided.

For the purposes of the original disclosure it is pointed out that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. A comprehensive explicit representation of all conceivable combinations of features and emphasis of the independence of the individual features from each other is dispensed with here only for the sake of brevity and readability of the description.

While the invention has been illustrated and described in detail in the drawings and the preceding description that illustration and description is only by way of example and is not deemed to be a limitation on the scope of protection as defined by the claims. The invention is not limited to the disclosed embodiments.

Modifications in the disclosed embodiments are apparent to the man skilled in the art from the drawings, the description and the accompanying claims. In the claims the word ‘have’ does not exclude other elements or steps and the indefinite article ‘a’ does not exclude a plurality. The mere fact that certain features are claimed in different claims does not exclude the combination thereof. References in the claims are not deemed to be a limitation on the scope of protection.

### LIST OF REFERENCES

1 drinks coaster
2 housing
3 top side of the housing 2
4 carrier surface of the housing 2
5 drinking glass
6 beer mat
7 bottom of the drinking glass 5
8 rim
9 drink
10 compartment
11 communication device
12 force sensor
13 accumulator
114 wall
15 processor
16 RFID reader
17 RFID transponder
18 Bluetooth module
19 interface
20 data network
21 computer
22 Bluetooth connection (first communication connection)
23 RFID connection (second communication connection)
24 RFID connection (third communication connection)
25 Internet
26 smartphone (mobile terminal device)
27, 27′ system

1. A drinks coaster (1) comprising
a housing (2) which is so designed that a drinking vessel (5) can be placed thereon, and
a wireless electronic communication device (11) arranged in the housing (2),
wherein the communication device (11) is of such a configuration and design that a first wireless communication connection (22) with an interface (19) can be provided by the communication device in operation of the drinks coaster (1), wherein data can be transmitted at least from the communication device (11) to the interface (19),
characterised in that
the communication device (11) is further configured and designed that a second wireless communication connection (23) with a contactlessly readable electronic information carrier (17) mounted on a drinking vessel (5) can be provided by the communication device in operation of the drinks coaster (1), wherein data can be read at least out of the electronic information carrier (17) and transmitted to the communication device (11).

2. A drinks coaster (1) according to the preceding claim characterised in that the communication device (11) is so designed and adapted that the first wireless communication connection (22) operates in accordance with a first transmission method and the second wireless communication connection (23) operates in accordance with a second transmission method different from the first transmission method.

3. A drinks coaster (1) according to one of the preceding claims characterised in that the communication device is so designed and adapted that the first wireless communication connection (22) is a wireless LAN connection, a Bluetooth connection, a mobile radio connection or an LPWA connection and that the second wireless communication connection (23) is a connection for reading out a RFID transponder.

4. A drinks coaster (1) according to one of the preceding claims characterised in that the drinks coaster (1) has a measuring device (12) for detecting a measurement parameter, wherein the measuring device (12) is operatively connected to the communication device (11) so that the measurement parameter can be transmitted in the form of data to the interface at least by way of the first communication connection (22).

5. A drinks coaster (1) according to one of the preceding claims characterised in that the drinks coaster (1) has a filling level measuring device (12) arranged in the housing (2), wherein the filling level measuring device (12) is so designed and adapted that a filling level of a drinking vessel (5) placed on the housing (2) can be detected with the filling level measuring device (12) and wherein the filling level measuring device (12) is so connected to the communication device (11) that measurement data generated by the filling level measuring device (12) can be transmitted to the communication device (11).

6. A drinks coaster (1) according to the preceding claim characterised in that the filling level measuring device (12) is selected from a force sensor which is so adapted and arranged that in operation of the drinks coaster (1) a weight of a drinking vessel (5) placed on the drinks coaster (1) can be detected with the force sensor (12), a capacitive sensor which is so adapted and arranged that in operation of the drinks coaster (1) an electrical capacitance dependent on the filling level of the drinking vessel (5) placed on the drinks coaster (1) can be detected with the capacitive sensor, or an optical sensor.

7. A drinks coaster (1) according to one of the preceding claims characterised in that the communication device (11) is further so designed and adapted that in operation of the drinks coaster (1) a third wireless communication connection (24) with a mobile terminal device (22) can be provided by the communication device, wherein data can be read at least out of the mobile terminal device (26) and transmitted to the communication device (11).

8. A drinks coaster (1) according to one of the preceding claims characterised in that the housing (2) has a top side (3) with a carrier surface (4) and an rim (8) which at least portion-wise surrounds the carrier surface (4) and projects with respect to the carrier surface (4) so that a beer mat (6) can be received on the carrier surface (4) and within the rim (8).

9. A drinks coaster (1) according to one of the preceding claims characterised in that the drinks coaster (1) has a display element connected to the communication device (11), wherein the display element is preferably a display or a light emitting diode or has a vibration alarm connected to the communication device.

10. A drinks coaster (1) according to one of the preceding claims characterised in that the drinks coaster (1) has a power supply (13), in particular an accumulator, which is arranged in the housing and connected to the communication device (11).

11. A system (27, 27′) comprising a drinks coaster according to one of the preceding claims, an interface (19) and a drinking vessel (5), having a contactlessly readable electronic information carrier (7) fitted thereon, wherein a first wireless communication connection (22) is provided between the communication device (11) of the drinks coaster (1) and the interface (19) so that data can be transmitted at least by the communication device (11) of the drinks coaster (1) to the interface (19) and wherein a second wireless communication connection (23) is provided between the communication device (11) of the drinks coaster (1) and the information carrier (17) so that data can be read at least out of the electronic information carrier (17) and transmitted to the communication device (11) of the drinks coaster (1).

12. A system (27, 27′) according to the preceding claim characterised in that the interface (19) is an access point of a data network (20), preferably an access point or a router, or that the interface is an interface of a mobile terminal device, preferably a mobile telephone.

13. A system (27, 27′) according to claim 11 or claim 12 characterised in that the system includes a mobile terminal device (26), wherein a third wireless communication connection (24) is provided between the communication device (11) of the drinks coaster (1) and the mobile terminal device (26) so that data can be read out at least from the mobile terminal device (26) and transmitted to the communication device (11) of the drinks coaster (1).

14. A system (27, 27′) according to one of claims 11 to 13 characterised in that the system further has a table having a contactlessly readable electronic information carrier mounted thereto or a stand having a contactlessly readable electronic information carrier mounted thereto for setting up on a table, wherein by way of a wireless communication connection between the communication device of the drinks coaster data can be at least read out of the electronic information carrier and transmitted to the communication device of the drinks coaster.

15. A method of data communication in a system (27, 27′) comprising a drinks coaster (1) having a housing (2) which is so adapted that a drinking vessel (5) can be placed thereon, and a wireless electronic communication device (11) arranged in the housing (2), an interface (19) and a drinking vessel (5) with a contactlessly readable electronic information carrier (17) mounted thereto, wherein by way of a first wireless communication connection (22) data can be transmitted at least from the communication device (11) of the drinks coaster (1) to the interface (19) and wherein by way of a second wireless communication connection (23) data are read at least out of the electronic information carrier (17) and transmitted to the communication device (11) of the drinks coaster (1).
